(19) United States
(12) Patent Application Publication
(10) Pub. No.: US 2012/0145418 A1
(43) Pub. Date: Jun. 14, 2012

(54) Misting blanket fire protection system

(76) Inventors: Kuojui Su, Van Nuys, CA (US); Ling Ju Su, Van Nuys, CA (US)

(21) Appl. No.: 13/373,896

(22) Filed: Dec. 5, 2011

Related U.S. Application Data
(60) Provisional application No. 61/458,941, filed on Dec. 6, 2010.

(51) Int. Cl. A62C 3/00

(52) U.S. Cl. 169/45; 169/54

(57) ABSTRACT

A Misting Blanket Fire Protection system is a solution for preventing buildings from being destroyed by wildfires. The system is easy to install and is an independent system that is able to operate independently from electricity and water supply from the city. This invention is a movable system which composes of a misting blanket, a water source and an engine water pump. The misting blanket releases water sprinkles to wet any building needing protection to prevent from catching fire when a wildfire approaches.

### CROSS REFERENCE OF RELATED APPLICATION

This is a non-provisional application of a provision application having an application number 61/458,941 and a filing date of Dec. 06, 2010.

### BACKGROUND OF THE PRESENT INVENTION

1. Field of Invention

This invention relates to a system and method for protecting buildings and properties from being destroyed by wildfires.

2. Description of Related Arts

Wildfires occur regularly in many parts of the United States. We see devastations caused by wildfires take place year after year in places such as California or Arizona where temperatures can get very high and humidity levels very low. Although firefighters are better trained and equipped than before, large wildfires continue to take place every year, overpowering firefighter resources, costing millions in property damage.

There are many patented wildfire protection systems. A method involves the use of chemicals to prevent damage from a fire. However, such method can be costly and not a suitable option for those who are averse to increasing use of chemicals in their living environment. Another method involves permanently installing a sprinkler like system on their homes or properties. Unfortunately not many home owners consider a wildfire protection system as something worth investing in order to protect their homes. A reason for this is that there usually is no sense of urgency for the homeowner until a wildfire is approaching their property. By then it is too late to do anything.

The rise in global temperatures is a phenomenon what will not go away anytime soon and the frequency of wildfire breakout will only increase. More efforts should be made in finding ways to better protect lives and properties from wildfires. It was with this spirit that the present invention was conceived as a best way to prevent houses and buildings from being destroyed by wildfires.

We hope that this new invention will be accepted and popularly used as we believe this invention offers an easy, effective solution for minimizing property damages caused by wildfires.

### SUMMARY OF THE PRESENT INVENTION

The main purpose of the present invention is to find a solution for preventing buildings and properties from being destroyed by wildfires. The present invention is a movable misting blanket that is easy to install and transport. The misting blanket is composed of narrow flexible water tubes and cross shaped, 4-pronged sprinkle nozzles. The nozzles connect the water tubes together in a crisscross pattern to form a net-like structure of the misting blanket. The nozzles serve both as connectors for connecting tubes and as sprinklers for releasing water to wet and cool down surfaces of buildings or properties that need protection from wildfires. Various water sources such as city water, water pools or water tanks can be used to supply water.

The misting blanket can be of any size. For the purpose of clarification, we recommend here a size of 8′×10′ as a good standard size for easy transportation and storage. The size of the misting blanket can also be customized according to the user's specification for fitting a specific building. Each misting blanket can be combined with one or more blankets to form a larger piece by connecting it to other blankets by way of screwing on one of its extension hoses onto a main channel connector of a another misting blanket.

As a wildfire approaches, the user installs the fire protection system by covering the surface of the building with a misting blanket and connecting the blanket to a water source such as the city water. An engine water pump is used when needed for raising the pressure of water coming from a low pressure water source such as a swimming pool. When a swimming pool is used as the water resource, a water filter may be used to filter out things that may clog water passage. Water tank is another water source that can be used when the city water and other forms of water source are not available. Once the installation is done and turned on, water sprinkles spouting out from the misting blanket wet and cool down the surface of the building to prevent the building from catching fire. At the same time, the misting blanket is wet itself and is protected from the danger of heat or fire embers.

The misting blanket system is a water efficient system that works effectively even in a situation where the water source is limited. The uniquely designed sprinkle nozzles release water in droplets so to conserve water. At the same time, A sufficient number of sprinkle nozzles are placed at regular intervals throughout the blanket to allow for water sprinkles to be released uniformly over the covered areas.

In addition to having features of easy installation and water efficiency, another advantage of the misting blanket is that the blanket is also easy to remove. The misting blanket, composed of flexible water tubes can be rolled up and stored away for future use without taking too much space. Since the misting blanket doesn't have to be affixed to a place permanently and is easy to install and un-install, it's an ideal fire protection tool for communal use. Institutions such as fire departments can provide misting blankets for the residents in their communities. When a wildfire breaks out, the fire department can immediately mobilize its personnel to distribute misting blankets to residents of areas in danger. In addition to misting blankets, the fire departments can also supply water tanks to those who need them as a water source.

The various functionality and advantages of the present invention mentioned above are not found in other types of wildfire protection system. The objects and advantages of the invention may be better understood and will become apparent from the accompanying drawings.

### BRIEF DESCRIPTION OF THE DRAWINGS

FIG. 1 illustrates a misting blanket according to the present invention.

FIG. 2 illustrates several misting blankets combined together to form an expanded misting blanket.

FIG. 3 is a lateral view of a sprinkle nozzle and a water tube.

FIG. 4 illustrates an expanded misting blanket anchored to a building.

### DETAILED DESCRIPTION OF THE PREFERRED EMBODIMENT

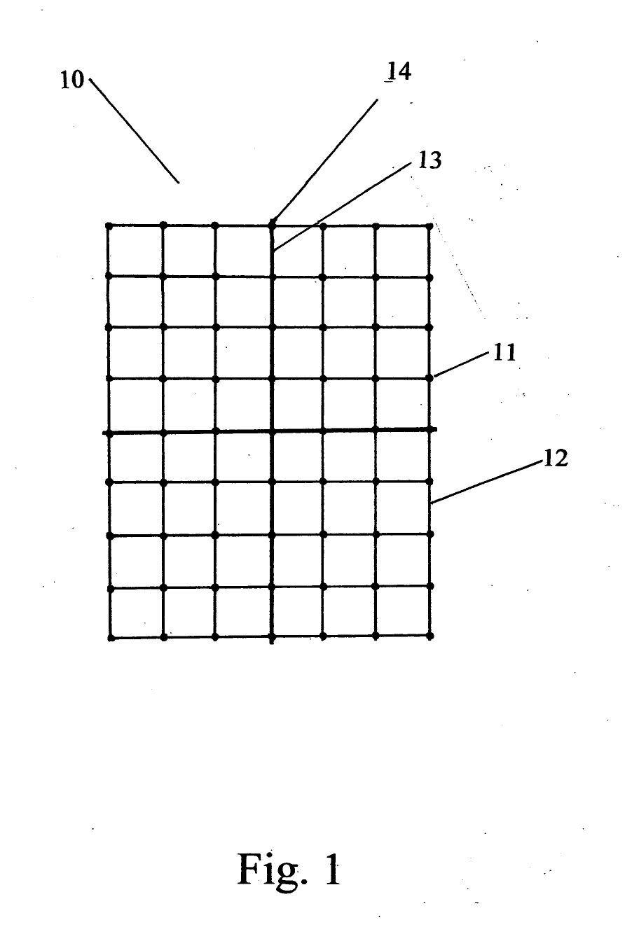

FIG. 1 illustrates a misting blanket (10) that, according to the present invention, includes a plurality of sprinkle nozzles (11) and a plurality of narrow, high pressure water tubes (12). The water tubes are connected together by the nozzles in a crisscross fashion. The nozzles serve both as connectors for connecting the tubes and as water sprinklers for releasing water. The tubes and nozzles are permanently screwed onto each other, which is done during the manufacturing process. There's no definite requirement for the length of the tubes for the system to work well. We suggest here that 2 ft be the length for water tubes. A main channel (13), consisting of larger water tubes, functions as a main conduit for delivering source water. At each end of the main channel is a main channel connector (14) for connecting to another misting blanket. The water tubes are bendable, which allows the misting blanket to lay over surfaces that are flat or angled. It also makes it possible to roll up the blanket for easy transport or storage. All water tubes are covered with a thin metal sheet to provide higher heat resistance and protection from debris. The water tubes are not metal. They are similar to the plastic hoses used in a sink or toilet plumbing system. Although the misting blanket can be of any size, a good suggested size is about 8 ft×10 ft.

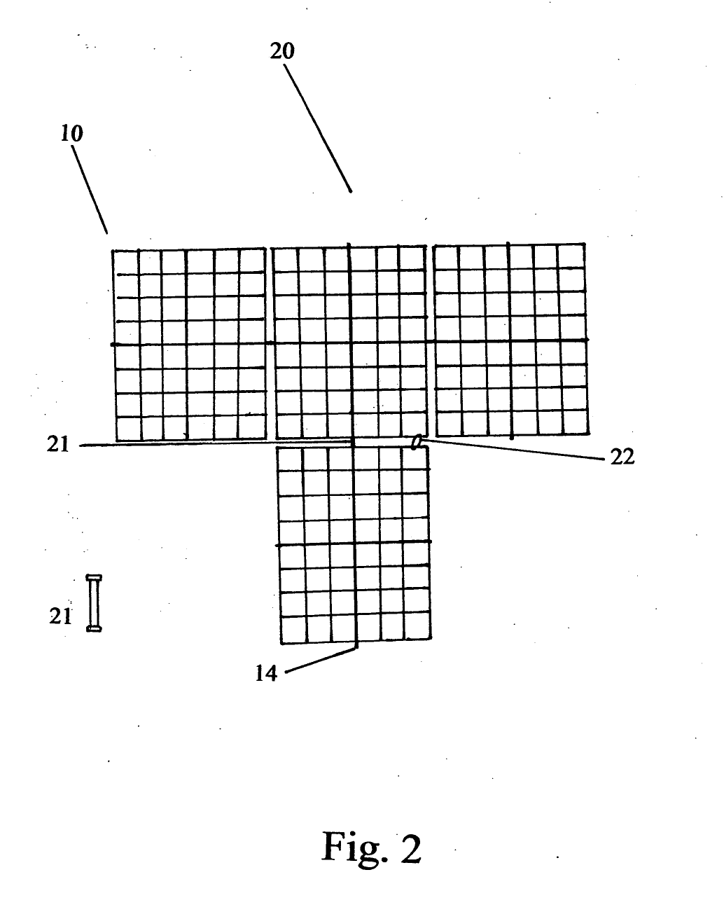

FIG. 2 is a view of an expanded misting blanket (20). Shown here are 4 misting blankets connected together to form the expanded blanket. At each end of the main channels is a main channel connector (14). Extension hoses (21) are screwed onto the main channel connectors to connect the blankets. Any main channel connectors not in use need to be capped off. As this is done on site, the user can determine how many blankets he needs to combine and add on as needed to provide sufficient coverage to cover surfaces that need protection. If the user chooses to, pieces of metal wire (22) can be used to tie the blankets together to keep in shape.

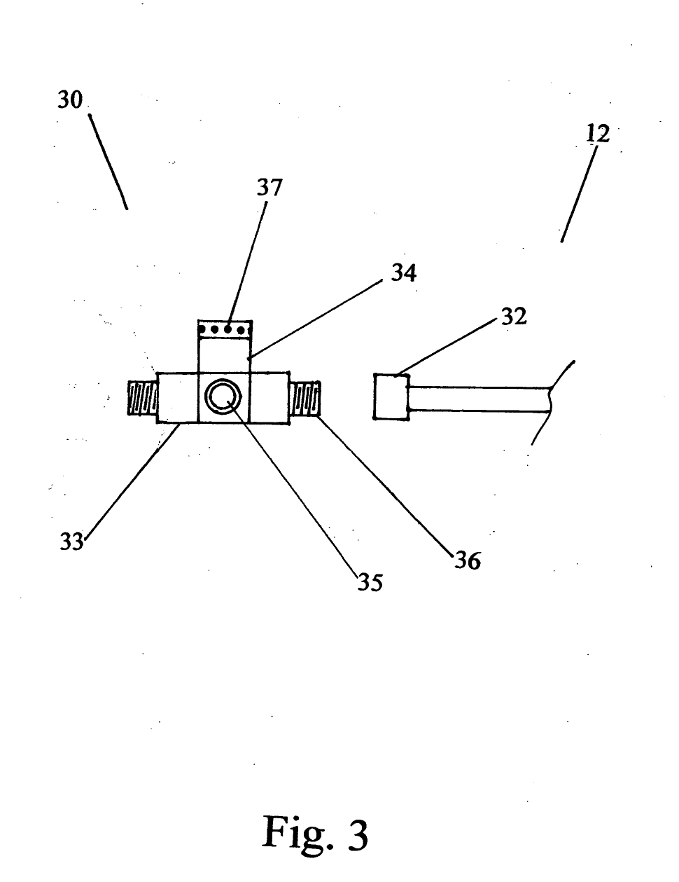

FIG. 3 is a lateral view of a sprinkle nozzle (30) and a water tube (12). The water tube (31) has a female coupler (32) on each end. The sprinkle nozzle has a protruded top (34) and 4 prongs that function as tube connectors (33). Each prong has an opening (35) to allow passage of water. At the end of each prong is a male coupler (36). When a prong is not attached with a main channel connector it is capped to stop water from flowing out. The protruded top is perforated with tiny releasing holes (37) for release of water. The type of water source used is a good determinant of the type of nozzle to use. The more limited the amount of water supplied by a water source, the better a choice of selecting nozzles with smaller releasing holes for use to conserve water supply.

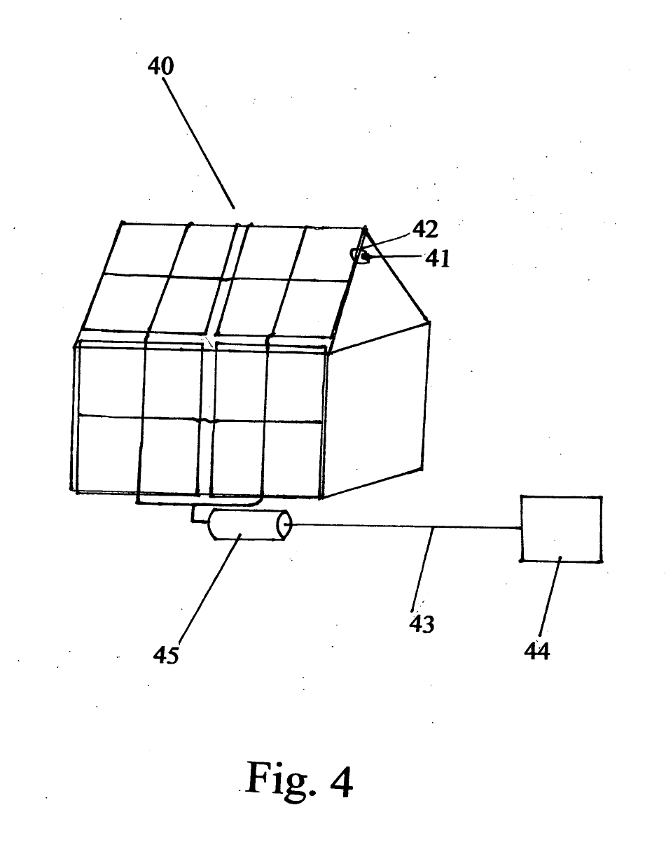

FIG. 4 is a view of an expanded misting blanket covering the roof and exterior walls of a building (40). There are various ways to anchor the misting blanket to the building depending on user's preference and skills. One easy way is to use screw nails. In this drawing, pieces of metal wire (41) are used to tie the blanket to screw nails (42) placed throughout the exterior surfaces of the building. Due to its unique net-like structure, once the misting blanket is anchored it is stable and will not be blown away by strong winds. A metal water supply hose (43) delivers the water from water source (44) to the blanket. Before entering the blanket, the water is cleaned by a water filter (45).

### CONCLUSION

The present invention of misting blanket is an effective, water efficient fire protection system. The flexible nature of the blanket makes it easy to lay over surfaces that are flat, uneven or angled. The misting blanket is easy to install and uninstall. It is also easy to transport and does not take too much space to store.

A crucial advantage of having the misting blanket fire protection system installed is that it allows property owners to leave their premises once the water source is turned on. Too often we see home owners endanger themselves when they try to stay as long as they can in order to manually hose down their properties to increase the chance of their properties survive an encroaching fire. The wetting method of the misting blanket system releasing water in droplets instead of large flows conserves water supply and enables it to last longer.

What is claimed is:

1. A misting blanket for wetting surfaces of a building, comprising:
a plurality of sprinkle nozzles;
a plurality of flexible water tubes
a blanket fire protection system comprising a first means functioning both as water sprinklers and connectors for connecting a second means in a crisscross pattern to form a net-like body of said misting blanket, and
said misting blanket comprising a first means for releasing water; a second means for delivering said water to a first means, and a water supply hose connected to said misting blanket from a water source to supply said water.

2. The misting blanket, as recited in claim 1, wherein each said sprinkle nozzle in said first means, having at least one releasing hole and a plurality of open-ended tube connectors, provide a conduit through which said water is transported and released into the air through said releasing holes.

3. The misting blanket, as recited in claim 2, wherein each said sprinkle nozzle contains one protruded wall on which one or more said releasing holes reside, and through which said water is released in different directions and angles.

4. The misting blanket, as recited in claim 1, wherein each said water tube in said second means has a female coupler at the end of each side.

5. The misting blanket, as recited in claim 3, wherein each said sprinkle nozzle having a plurality of tube connectors each with a male coupler to connect to female couplers of said water tubes in said second means.

6. The misting blanket, as recited in claim 5, wherein each said sprinkle nozzle is shaped like a cross with 4 prongs that serve as tube connectors for connecting with said water tubes and as such connecting process is repeated, a crisscross pattern appears which results in said blanket having a net-like structure.

7. The misting blanket, as recited in claim 6, wherein at least one row of said water tubes are larger and form a main channel through which water enters and is distributed to all sprinkle nozzles in said first means and at each end of said main channel attached is a main channel connector.

8. The misting blanket, as recited in claim 7, comprising flexible water tubes making it possible to lay over an angled surface or roll up for storage or transport.

9. The misting blanket, as recited in claim 7, wherein each said main channel connector is attachable to an extension hose for connecting to one or more misting blankets to form a larger piece.

10. A method of installing misting blanket fire protection system on a building, comprising the steps of:
(a) placing a plurality of misting blankets on a surface of said building and combining said misting blankets together using extension hoses as connectors and water passage extensions to form a larger misting blanket,
(b) connecting one or more said main channel connector to a water supply hose,
(c) connecting said water supply hose to a water source.

11. The method as recited in claim 10 wherein, in the step (a), further comprises the steps of
(a-1) capping off any said main channel connectors not being connected to a said extension hose or water supply hose,
(a-2) anchoring each said misting blanket to said building by using metal wires or any suitable method.

12. The method as recited in claim 10 wherein, in the step (b), further comprises the steps of
(b.1) installing a water filter between said misting blanket and water source.

13. The method, as recited in claim 10, wherein said misting blanket is made of flexible water tubes which makes possible laying over an un-even or angled surface or rolling up for easy transportation and storage.

14. The method, as recited in claim 10, wherein said misting blanket releases sprinkled water to wet and cool said misting blanket and said building to prevent from catching fire.

15. The method, as recited in claim 10, wherein said misting blanket is water efficient and suitable for use when a water source is limited.
